(19) United States
(12) Patent Application Publication
(10) Pub. No.: US 2012/0303289 A1
(43) Pub. Date: Nov. 29, 2012

(54) COMBINED ON-LATTICE/OFF-LATTICE OPTIMIZATION METHOD FOR RIGID BODY DOCKING

(76) Inventor: Anders Ohrn, Vancouver (CA)

(21) Appl. No.: 13/513,494

(22) PCT Filed: Dec. 2, 2010
(86) PCT No.: PCT/CA10/01923

§ 371 Date: Aug. 13, 2012

Related U.S. Application Data
(60) Provisional application No. 61/266,059, filed on Dec. 2, 2009.

(51) Int. Cl. G06F 19/00

(52) U.S. Cl. 702/23

(57) ABSTRACT

The invention provides a method of sampling conformation space for an interacting pair comprising (a) an approaching body characterized by an approaching body quaternion and (b) a central body characterized by a central body quaternion, wherein the interacting pair is characterized by an energy and a center of mass vector, the method comprising: (i) performing a first minimization of the energy by varying the approaching body quaternion through off-lattice transformations and then, sequentially, (ii) performing a first translation of the approaching body toward the central body along the center of mass vector, wherein the translation consists of an on-lattice transformation.

### CROSS-REFERENCE TO RELATED APPLICATIONS

This application claims under 35 USC 119(e) the benefit of U.S. Application 61/266,059, filed Dec. 2, 2009, which is incorporated by reference in its entirety.

### TECHNICAL FIELD

The invention relates to the field of chemical modeling and design.

### BACKGROUND

Intermolecular interactions are responsible for a wide variety of important biological phenomena from immune recognition to transcription initiation and signal transduction. Rigid-body docking can provide valuable insight into the nature of a molecular combination and/or the likelihood of formation of a potential molecular complex and has many potential uses, for example, within the context of rational drug discovery. Rigid-body docking may be appropriate, for example, for docking small, rigid molecules (or molecular fragments) to a simple protein with a well-defined, nearly rigid active site. As another example, rigid-body docking may also be used to more efficiently and rapidly screen out a subset of likely nonactive ligands in a molecule library for a given target, and then applying more onerous flexible docking procedures to the surviving candidate molecules. Rigid-body docking may also be suitable for de novo ligand design and combinatorial library design. These methods are equally suitable for docking other interacting pairs, such as two proteins.

Previous work done on searching a potential energy surface of two docking rigid bodies involve either completely on-lattice or completely off-lattice approaches. For example, in known docking methods using fast Fourier transform (FFT) or genetic algorithms, the translational and rotational space are optimized in a completely on-lattice approach. In FFT docking methods, the grid is searched for low-energy points using the mathematical operation of convolution. This is a common method in protein docking and exists in many different forms. For examples and additional references, see Vajda and Camacho, TRENDS in Biotechnolgy, 2004, 22(3): 110-116; Smith and Sternberg, Current Opinion in Structural Biology, 2002, 12: 28-35; Mandell et al., Protein Engineering, 2001, 14: 105-113 and Kowalsman and Eisenstein, Bioinformatics, 2007, 23: 421-426. Genetic algorithms use a genetic optimization algorithm to minimize the energy. See Smith and Sternberg; and Gardiner et al., Proteins: Structure, Function, and Genetics, 2001, 44: 44-56. In known docking methods using Brownian dynamics and real space minimization (with Monte Carlo), the translational and rotational space are optimized in a completely off-lattice approach. See, for example, Fernandez-Recio, Protein Science, 2002, 11: 280-291. Real-space minimization is often combined with some additional method to overcome local minima, for example Monte Carlo or simulated annealing. See Zacharias, Protein Science, 2003, 12: 1271-1282; Gray et al., Journal of Molecular Biology, 2003, 331: 281-299; and Dominguez, Journal of the American Chemical Society, 2003, 125: 1731-1737.

There is currently a need for improved methods of searching conformation space of interacting bodies. These methods are provided by the present invention.

### SUMMARY OF INVENTION

In one aspect, the invention provides a method of sampling conformation space for an interacting pair comprising (a) an approaching body characterized by an approaching body quaternion and (b) a central body characterized by a central body quaternion, wherein the interacting pair is characterized by an energy and a center of mass vector, the method comprising: (i) performing a first minimization of the energy by varying the approaching body quaternion through off-lattice transformations and then, sequentially, (ii) performing a first translation of the approaching body toward the central body along the center of mass vector, wherein the translation consists of an on-lattice transformation. The method further optionally comprises, if the approaching body and the central body do not clash severely, (iii) performing a second minimization of the energy by varying the approaching body quaternion through off-lattice transformations and then, sequentially, (iv) performing a second translation of the approaching body toward the central body along the center of mass vector, wherein the translation consists of an on-lattice transformation.

The invention provides methods that take advantage of separating translational and rotational space to construct an effective optimization method. These methods can be used to search for low energy configurations for a given potential. The effectiveness of the methods is due in part to the use of quantities that are easy to evaluate and their ability to navigate the potential energy surface of a system with its multitude of local and many times irrelevant minima. In the combined on-lattice/off-lattice model, optimization in rotational space is a constrained, but continuous problem, hence “off-lattice.” The stepping in translational space between points is discretized, hence “on-lattice.” The translational and rotational spaces are orthogonal, which implies that the constraining of the minimization procedure is trivial and leads to a simple and mathematically well-defined minimization protocol.

### BRIEF DESCRIPTION OF DRAWINGS

FIG. 1 shows an illustration of the system that is being docked. There are two bodies, A and B. The vector R describes the relative location of the center of mass of the two bodies. Q_{A} and Q_{B} are quaternions that describe how the molecular frames of A and B, respectively, are rotated relative to the laboratory frame, L. R is optimized in an on-lattice way, Q_{A} and Q_{B} are optimized in an off-lattice way.

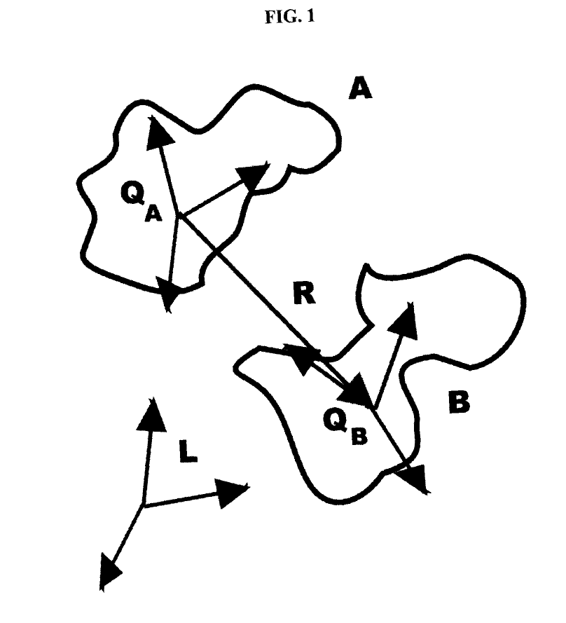

FIG. 2 shows the spectra for the four different DroqDock methods from two calculations using different random seeds. The number of starting configurations is 4000.

FIG. 3 shows the normalized spectra of energy sampled by the four different methods. In the case of DroqDock-IV, two additional calculations using fewer starting configurations are also presented.

### DESCRIPTION OF EMBODIMENTS

Two or more internally rigid interacting bodies have at least one configuration that is of lowest energy. To find the lowest configuration or configurations is an optimization problem. The present invention provides methods to solve this optimization problem based on a separation of the rigid body degrees of freedom into translational and rotational components. The translational component describes the spatial separation of the center of mass for the rigid bodies and is treated in an on-lattice way. The rotational component describes the relative orientation of the rigid bodies and is treated in an off-lattice way. For a given configuration, methods of the present invention are used to solve the off-lattice problem for a fixed translational component with a standard energy minimization in continuous space.

Thus, in one aspect, the invention provides a method of sampling conformation space for an interacting pair comprises (a) an approaching body characterized by an approaching body quaternion and (b) a central body characterized by a central body quaternion, wherein the interacting pair is characterized by an energy and a center of mass vector, the method comprising: (i) performing a first minimization of the energy by varying the approaching body quaternion through off-lattice transformations and then, sequentially, (ii) performing a first translation of the approaching body toward the central body along the center of mass vector, wherein the translation consists of an on-lattice transformation, and optionally, if the approaching body and the central body do not clash severely, (iii) performing a second minimization of the energy by varying the approaching body quaternion through off-lattice transformations and then, sequentially, (iv) performing a second translation of the approaching body toward the central body along the center of mass vector, wherein the translation consists of an on-lattice transformation.

The present methods can be applied to any set of bodies. A “body” can be any atom, molecule or any distinct group or combination of atoms and molecules. Exemplary bodies include small molecules (i.e., having low molecular weight (e.g. <1000 Da, and typically between 300 and 700 Da), e.g., drugs), saccharides (e.g. polysaccharides), peptides (e.g., proteins) and nucleotides (e.g. polynucleotides). The methods are generally applied to two or more different bodies that interact with each other in some way. For example, two bodies may be attracted to each other through an attractive force, sometimes in such a way that the two bodies bind to each other. The present methods can be used to model the interaction between two members of an “interacting pair,” which comprise an “approaching body” and a “central body.” These terms are used for conveniently labeling two different members of an interacting pair. Since they are relative terms, they may be interchanged in different embodiments. Examples of approaching body/central body pairs include various ligand/receptor pairs, such as antigen/antibody, inhibitor/enzyme, activator/enzyme, small molecule/receptor and so on.

A center of mass coordinate and relative orientation to a fixed coordinate system can define the configuration of a rigid body. Two bodies may be related to each other through one or more quantitative measures, such as an energy, a center of mass vector that points from one body's center of mass to the other's and one or more quaternions that describe, for example, the internal coordinate axes of one body relative to the other. The center of mass vector can be thought of as representing translational space, while the quaternion can be thought of as representing rotational space. The potential used to calculate the energy can comprise any number of suitable terms as understood in the art, as long as the potential is of realistic complexity.

Typically in the present methods, a first minimization is performed by varying the approaching body quaternion through off-lattice transformations. An “off-lattice” transformation refers to a continuous transformation. In some embodiments, either one of the bodies undergoes off-lattice transformations during this step. In some embodiments, both bodies undergo off-lattice transformations during this step. After the first minimization, the approaching body is translated toward the central body along the center of mass vector through an on-lattice transformation. An “on-lattice” transformation refers to a transformation that occurs through a discrete step. In other words, in an example of an on-lattice transformation, the center of mass of a body can be thought of as moving from one point to another point of a grid.

The minimization and translation steps of the present methods may be repeated if the approaching body and the central body do not clash severely. Two bodies are deemed to “clash severely” if the atoms or particles in the bodies (e.g. two proteins to be docked) are found at very short non-bonded distances (e.g., equal to or less than about 2.0 Å, 2.5 Å or 3.0 Å, in particular less than about 2.5 Å) apart, thus creating a large repulsive interaction. Severely clashing bodies raise the energy of the interaction, and so in some embodiments, the steps may be repeated if the energy of the pair is not greater than some threshold that may be arbitrarily chosen by the practitioner. For example, the threshold may be set to avoid improbable states as determined by the practitioner or understood in the art. In another example, the threshold may be a ceiling for the repulsive interactions arising from the close proximity of two or more atoms in space. Thus, the present methods contemplate an optionally iterative procedure.

In one embodiment, the approaching body quaternion is varied continuously.

In one embodiment, the translation of the approaching body consists of moving the approaching body a discrete distance toward the central body. In one embodiment, the discrete distance is predetermined by the practitioner. In other words, the energy is not minimized during the translation.

In one embodiment, the center of mass vector is constant during a minimization of the energy. Thus, in one embodiment, minimization of the energy does not comprise translation of a body.

In one embodiment, the approaching body quaternion and the central body quaternion are constant during a translation of the approaching body. Thus, in one embodiment, neither the approaching body nor the central body rotates during the translation of the approaching body.

After minimization the optimal energy of the constrained system can be recorded. The energies of calculated during minimization can be used in later data processing and analysis. In one embodiment, a minimization of energy comprises recording a plurality of energies of the interacting pair and the method further comprises calculating an energy spectrum based on the plurality of energies.

In one embodiment, the method starts with a given configuration of the two rigid bodies, C1. This configuration corresponds to one center of mass vector, R1, and one quaternion to describe the relative orientation, Q1. With a standard minimization method (steepest descent, for example) the energy is minimized by optimizing the rotational space only—the translational space is constrained. Upon convergence of the minimization in rotational space, the energy is recorded, E1, along with the vector R1 and the optimized quaternion Q1_opt. A new configuration is created, C2, by taking one step in translational space that takes the center of mass of the two bodies closer. The rotational degrees of freedom are optimized for the new configuration. The procedure is iterated. The translation of the center of mass of the two bodies closer together is terminated once the two bodies clash severely. A new random configuration is then generated, and the procedure of gradually translating the bodies closer—driving them—is repeated.

The present methods can be conceptually divided into four subclasses, referred to as DroqDock-I, DroqDock-II, DroqDock-III and DroqDock-IV. While reference is made to proteins, these subclasses apply to any type of body.

In DroqDock-I, the central protein (CP) is always fixed. When the approaching protein (AP) has reached a local minimum in rotational space for the fixed R, the next configuration in translational space is generated by resetting the quaternion of the AP to its initial value.

In DroqDock-II, the CP is allowed to rotate around its internal axis. The next configuration in translational space for the AP is generated by resetting the quaternion of the AP to its initial value.

In DroqDock-III, the CP is always fixed. The next configuration in translational space for the AP is generated by forwarding the quaternion from the optimal position in the previous point in translational space to be the initial value of the next Q-optimization.

In DroqDock-IV, the CP is allowed to rotate around its internal axis. The next configuration in translational space for the AP is generated by forwarding the quaternion from the optimal position in the previous point.

In a simple hierarchy DroqDock-I is the most rigid method, DroqDock-IV the most flexible and DroqDock-II and DroqDock-III are at some intermediate point.

Accordingly, in one embodiment, the step of performing the first minimization of energy comprises (i) maintaining the central body fixed and (ii) varying the approaching body quaternion from an initial value until a first local minimum energy has been reached, and the step of performing the second minimization of energy comprises (iii) resetting the approaching body quaternion to the initial value and (iv) varying the approaching body quaternion starting from the initial value until a second local minimum energy has been reached.

In one embodiment, the step of performing the first minimization of energy comprises (i) varying the central body quaternion and (ii) varying the approaching body quatemion from an initial value until a first local minimum energy has been reached, and the step of performing the second minimization of energy comprises (iii) resetting the approaching body quaternion to the initial value and (iv) varying the approaching body quaternion starting from the initial value until a second local minimum energy has been reached.

In one embodiment, the step of performing the first minimization of energy comprises (i) maintaining the central body fixed and (ii) varying the approaching body quaternion to an intermediate approaching body quaternion wherein a first local minimum energy has been reached, and the step of performing the second minimization of energy comprises (iii) varying the approaching body quatemion starting from the intermediate approaching body quaternion until a second local minimum energy has been reached.

In one embodiment, the step of performing the first minimization of energy comprises (i) varying the central body quaternion and (ii) varying the approaching body quaternion to an intermediate approaching body quaternion wherein a first local minimum energy has been reached, and the step of performing the second minimization of energy comprises (iii) varying the approaching body quaternion starting from the intermediate approaching body quaternion until a second local minimum energy has been reached.

### Implementation in a Computer System

Any method described herein may be implemented as one or more computer programs that are executed on one or more programmable computers, each comprising a processor and a data storage system. A computer program is a set of instructions that can be used, directly or indirectly, in a computer to perform a certain activity or to bring about a certain result. A computer program can be written in any form of programming language, including compiled or interpreted languages, and it can be deployed in any form, including as a stand-alone program or as a module, component, subroutine, function, procedure or other unit suitable for use in a computing environment.

The computer program can be stored on a computer-readable storage system. Examples of storage systems include, without limitation, optical disks such as CD, DVD and Blu-ray Discs (BD); magneto-optical disks; magnetic media such as magnetic tape and internal hard disks and removable disks; semi-conductor memory devices such as EPROM, EEPROM and flash memory; and RAM.

A computer-readable storage system may be physically transformed such that it contains a computer program. It will be appreciated by one of skill in the art that a computer-readable storage system comprising instructions for performing any method disclosed herein is physically distinct from a computer-readable storage system that does not comprise such instructions. In other words, any given computer-readable storage system must be physically transformed to comprise instructions for performing any method disclosed herein. A computer-readable storage system comprising computer executable instructions, such as instructions for performing any method disclosed herein, is physically configured in such a manner so as to cause a computer interacting with the storage system to perform a process or a method. One of skill in the art will appreciate that a computer-readable storage system comprising computer executable instructions for performing any method disclosed herein, when accessed and read by a general purpose computer, will transform the general purpose computer into a special purpose computer.

Thus, in one aspect, the invention provides a computer-readable storage system comprising computer executable instructions for performing any method described herein. In one embodiment, a computer-readable storage system comprises computer executable instructions for a method of sampling conformation space for an interacting pair comprising (a) an approaching body characterized by an approaching body quaternion and (b) a central body characterized by a central body quaternion, wherein the interacting pair is characterized by an energy and a center of mass vector, the method comprising: (i) performing a first minimization of the energy by varying the approaching body quaternion through off-lattice transformations and then, sequentially, (ii) performing a first translation of the approaching body toward the central body along the center of mass vector, wherein the translation consists of an on-lattice transformation, and optionally, if the approaching body and the central body do not clash severely, (iii) performing a second minimization of the energy by varying the approaching body quaternion through off-lattice transformations and then, sequentially, (iv) performing a second translation of the approaching body toward the central body along the center of mass vector, wherein the translation consists of an on-lattice transformation.

In a further aspect, the invention provides a computer system for performing any method described herein, the computer system comprising a data storage system and a processor comprising instructions for performing any method described herein. In one embodiment, a computer system for comprises (1) a data storage system and (2) a processor comprising instructions for a method of sampling conformation space for an interacting pair comprising (a) an approaching body characterized by an approaching body quaternion and (b) a central body characterized by a central body quaternion, wherein the interacting pair is characterized by an energy and a center of mass vector, the method comprising: (i) performing a first minimization of the energy by varying the approaching body quaternion through off-lattice transformations and then, sequentially, (ii) performing a first translation of the approaching body toward the central body along the center of mass vector, wherein the translation consists of an on-lattice transformation, and optionally, if the approaching body and the central body do not clash severely, (iii) performing a second minimization of the energy by varying the approaching body quaternion through off-lattice transformations and then, sequentially, (iv) performing a second translation of the approaching body toward the central body along the center of mass vector, wherein the translation consists of an on-lattice transformation.

It will be appreciated by one of skill in the art that a processor comprising instructions for performing any method disclosed herein is physically distinct from a processor that does not comprise such instructions. In other words, any given processor must be physically transformed to comprise instructions for performing any method disclosed herein.

The processor and the data storage system can be supplemented by or incorporated in application-specific integrated circuits (ASICs). When read into the processor of the computer, which is thus physically transformed, and executed or further processed before execution, the instructions of the program cause the programmable computer to carry out the various operations described herein. The processor and the data storage system are typically connected by a bus.

To provide for interaction with a user, the invention can be implemented on a computer comprising a display device such as, for example, a cathode ray tube (CRT) or liquid crystal display (LCD) monitor for displaying information to the user. The user can provide input, for example, via a keyboard, a touch screen or a pointing device such as a mouse or a trackpad. The various data and molecular conformations generated by the present methods can be represented graphically using modeling and graphics software.

The different aspects and embodiments described herein can be implemented in a computer system that includes a backend component such as a data server, a middleware component such as an application server or an Internet server, or a front end component such as a client computer having a user interface, Internet browser or any combination thereof. The components of the system can be connected by any form or medium of digital data communication.

The present methods can be implemented on hardware in a variety of configurations. Thus, in some embodiments, computational processes (such as, for example, a plurality of molecular dynamics simulations) are performed in parallel on nodes of a computer cluster, in a distributed computing system or on graphics processing units as these configurations are understood in the art.

Without intending to be limiting, the following examples are provided to give those of ordinary skill in the art a complete disclosure and description of how to make and use the subject invention, and are not intended to limit the scope of what is regarded as the invention. Efforts have been made to ensure accuracy with respect to the numbers used (e.g. amounts, temperature, concentrations, etc.) but some experimental errors and deviations should be allowed for.

### EXAMPLES

### Example 1

The methods of the invention have been tested on a potential energy surface that is simple but realistic for the protein-docking problem. Here, actin and Vitamin D binding protein (see Protein Data Bank ID 1KXP) were examined. A number of different DroqDock calculations were run using the coarse-grained C-beta-potential, which allows a comprehensive sampling on a potential energy surface that is representative of that found in a protein docking problem. The initial configurations were randomly generated. The energy spectrum of the optimized configurations provides for a good understanding of how the different methods perform in finding low energy configurations.

The first issue to verify is that the number of starting configurations is sufficiently large for making statistically significant assertions. This is done by the following very simple procedure: two calculations are run with different random seed. If the spectra of the two calculations differ very little, the sampling is saturated.

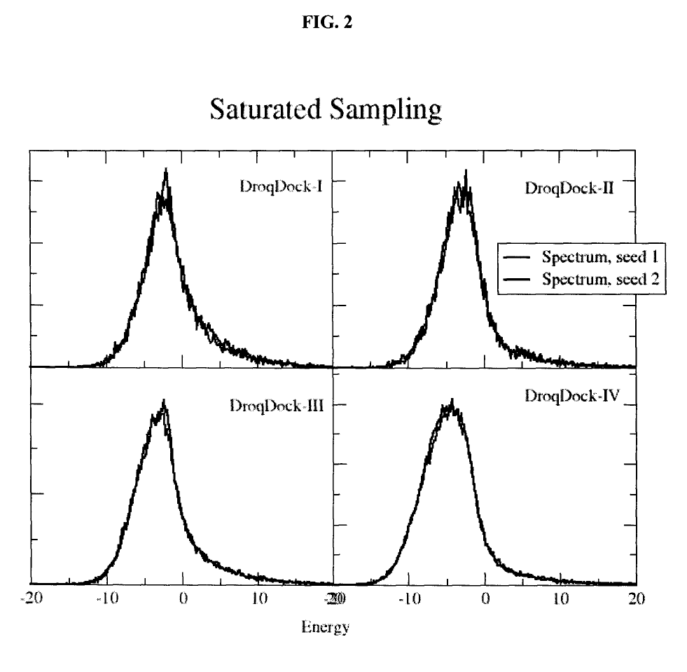

From FIG. 2, it is safe to say that with 4000 starting configurations, the sampling is saturated given the small difference between the two spectra in each of the four subfigures.

It should be noted that the same number of starting configurations does not lead to the same number of sampled configurations for the four methods. Table 1 shows data for which this is the case.

TABLE 1
Number of Starting and Sampled Configurations for the Different Types of
Calculations

| DroqDock Subclass | Starting Configurations | Sampled Configurations |
|---|---|---|
| I | 4000 | 10100 |
| II | 4000 | 10100 |
| III | 4000 | 36000 |
| IV | 4000 | 64000 |
| IV | 1000 | 15700 |
| IV | 250 | 3900 |

What is evident is that DroqDock-III and even more so DroqDock-IV are more effective in sampling the space starting from the same density of starting configurations. Using significantly fewer starting configurations, DroqDock-IV is able to sample the same density of points (but not the same type of points, vide infra) as the methods DroqDock-I and DroqDock-II.

### Comparison of Spectra

The previous section only dealt with the number of points sampled, not the type of points. This section compares the energy spectra of the various calculations.

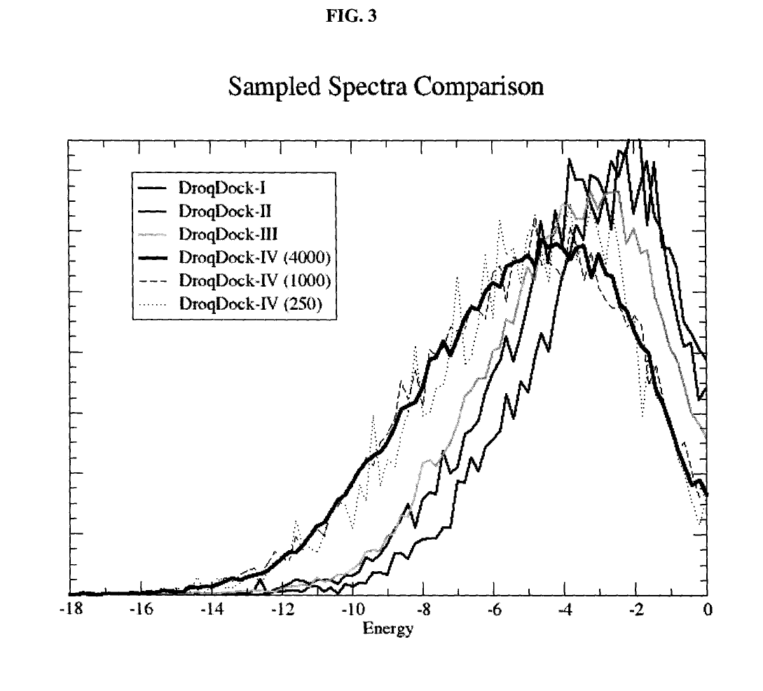

The results in FIG. 3 clearly show that DroqDock-IV is the best at sampling low energy configurations. This is not due to the fact that DroqDock-IV samples more points. Even in calculations that sample fewer points (such as in calculations with 250 starting configurations, where the total number of sampled points is less than that of DroqDock-I), the DroqDock-IV spectra are qualitatively similar to each other, but qualitatively different from the other three methods.

Methods combining an off-lattice and an on-lattice optimization have thus been shown to be effective. These methods successfully sample the low energy parts of the potential energy surface. Of the four subclasses, DroqDock-IV is found to sample the greatest density of low-energy configurations and is hence superior.

The articles “a,” “an” and “the” as used herein do not exclude a plural number of the referent, unless context clearly dictates otherwise. The conjunction “or” is not mutually exclusive, unless context clearly dictates otherwise. The term “include” is used to refer to non-exhaustive examples.

All references, publications, patent applications, issued patents, accession records and databases cited herein, including in any appendices, are incorporated by reference in their entirety for all purposes.

1. A method of sampling conformation space for an interacting pair comprising (a) an approaching body characterized by an approaching body quaternion and (b) a central body characterized by a central body quaternion, wherein the interacting pair is characterized by an energy and a center of mass vector, wherein the center of mass vector is bounded by a center of mass of the approaching body and a center of mass of the central body, the method comprising:
(i) performing, using a suitably programmed computer, a first minimization of the energy by varying the approaching body quaternion through off-lattice transformations and then, sequentially,
(ii) performing, using a suitably programmed computer, a first translation of the approaching body toward the central body along the center of mass vector, wherein the translation consists of an on-lattice transformation, and
optionally, if the approaching body and the central body do not clash severely,
(iii) performing, using a suitably programmed computer, a second minimization of the energy by varying the approaching body quaternion through off-lattice transformations and then, sequentially, and
(iv) performing, using a suitably programmed computer, a second translation of the approaching body toward the central body along the center of mass vector, wherein the translation consists of an on-lattice transformation.

2. The method of claim 1 wherein the approaching body quaternion is varied on a continuous scale.

3. The method of claim 1 wherein the translation of the approaching body consists of moving the approaching body a discrete distance toward the central body.

4. The method of claim 1 wherein the center of mass vector is constant during the first or second minimization of the energy.

5. The method of claim 1 wherein the approaching body quaternion and the central body quaternion are constant during the first or second translation of the approaching body.

6. The method of claim 1 wherein the step of performing the first minimization of the energy comprises
(i) maintaining the central body fixed and
(ii) varying the approaching body quaternion from an initial value until a first local minimum energy has been reached and
wherein the step of performing the second minimization of the energy comprises
(iii) resetting the approaching body quaternion to the initial value and
(iv) varying the approaching body quaternion starting from the initial value until a second local minimum energy has been reached.

7. The method of claim 1 wherein the step of performing the first minimization of energy comprises
(i) varying the central body quaternion and
(ii) varying the approaching body quaternion from an initial value until a first local minimum energy has been reached and
wherein the step of performing the second minimization of energy comprises
(iii) resetting the approaching body quaternion to the initial value and
(iv) varying the approaching body quaternion starting from the initial value until a second local minimum energy has been reached.

8. The method of claim 1 wherein the step of performing the first minimization of the energy comprises
(i) maintaining the central body fixed and
(ii) varying the approaching body quaternion to an intermediate approaching body quaternion wherein a first local minimum energy has been reached and
wherein the step of performing the second minimization of the energy comprises
(iii) varying the approaching body quaternion starting from the intermediate approaching body quaternion until a second local minimum energy has been reached.

9. The method of claim 1 wherein the step of performing the first minimization of the energy comprises
(i) varying the central body quaternion and
(ii) varying the approaching body quaternion to an intermediate approaching body quaternion wherein a first local minimum energy has been reached and
wherein the step of performing the second minimization of the energy comprises
(iii) varying the approaching body quaternion starting from the intermediate approaching body quaternion until a second local minimum energy has been reached.

10. The method of claim 1 wherein the first or second minimization of the energy comprises recording a plurality of energies of the interacting pair and wherein the method further comprises calculating an energy spectrum based on the plurality of energies.

11. A computer readable medium comprising non-transitory instructions for performing the method of claim 1.

12. A computer system comprising
one or more processors;
memory; and
one or more programs, wherein the one or more programs are stored in the memory and are configured to be executed by the one or more processors, the one or more programs for sampling conformation space for an interacting pair comprising (a) an approaching body characterized by an approaching body quaternion and (b) a central body characterized by a central body quaternion, wherein the interacting pair is characterized by an energy and a center of mass vector, wherein the center of mass vector is bounded by a center of mass of the approaching body and a center of mass of the central body, the one or more programs including instructions for:
(i) performing a first minimization of the energy by varying the approaching body quaternion through off-lattice transformations and then, sequentially,
(ii) performing a first translation of the approaching body toward the central body along the center of mass vector, wherein the translation consists of an on-lattice transformation, and
optionally, if the approaching body and the central body do not clash severely,
(iii) performing a second minimization of the energy by varying the approaching body quaternion through off-lattice transformations and then, sequentially, and
(iv) performing a second translation of the approaching body toward the central body along the center of mass vector, wherein the translation consists of an on-lattice transformation.

13. The method of claim 1 wherein the approaching body and the central body are deemed to not clash severely when no atom or particle in the approaching body is within a cutoff distance with any atom or particle in the central body.

14. The method of claim 13, wherein the cutoff distance is 3.0 Å.

15. The method of claim 13, wherein the cutoff distance is 2.5 Å.

16. The method of claim 1, wherein the approaching body is a molecule having a molecular weight of less than 1000 Daltons and the central body is a protein or a polynucleotide.

17. The method of claim 1, wherein the approaching body is a molecule having a molecular weight of less than 1000 Daltons and the central body is a protein or a polynucleotide.

18. The method of claim 1, wherein the approaching body is a saccharide or peptide.

19. The method of claim 1, wherein the central body is a saccharide or peptide.

20. The method of claim 1, wherein the first minimization of the energy is performed in accordance with a steepest descent schedule.
